(19) United States
(12) Patent Application Publication
(10) Pub. No.: US 2023/0360114 A1
(43) Pub. Date: Nov. 9, 2023

(54) COMPUTER GAME SYSTEM CALENDAR

(71) Applicant: Sony Interactive Entertainment LLC, San Mateo, CA (US)

(72) Inventors: Sidhartha Singh, Brampton (CA); Adrien Pringle, Etobicoke (CA); Tianhou Arist Xu, Thornhill (CA); Charles Zheng, Waterloo (CA); Daniel Qu, Richmond Hill (CA); Elysia Wang, Markham (CA); Jenny Tai, Kanata (CA); Muradil Udun, Calgary (CA); Nikashan Thavaruban, Mississauga (CA); Syed Saad Mukhtar, North York (CA); Tony Chen, North York (CA); Yikai Zhou, Toronto (CA)

(21) Appl. No.: 17/737,412

(22) Filed: May 5, 2022

(51) Int. Cl. G06Q 30/06; G06Q 10/10; A63F 13/79

(52) U.S. Cl. CPC G06Q 30/0641; G06Q 30/0633; G06Q 10/1093; A63F 13/79

(57) ABSTRACT

A calendar UI is provided showing on one side a calendar of events in day of the month format and on the other side a column of tiles, each corresponding to an event on the calendar and selectable to invoke a web page to play a game or purchase a product or hot launch the user into a game.

### FIELD

The present application relates generally to computer game system calendars.

### BACKGROUND

As recognized herein, in networked computer game systems, a large number of events such as future game plays, future game releases, and so on may be difficult for a gamer to keep track of.

### SUMMARY

An apparatus includes at least one computer storage that is not a transitory signal and that in turn includes instructions executable by at least one processor to present on a computer display a calendar comprising fields some or all of which indicate respective computer game events. The instructions are executable to present, next to the calendar, plural selectors each associated with a computer game event and selectable to open a respective Web page associated with the respective computer game event of the respective selector.

In example embodiments the computer game events represented by the selectors may be the same computer game events on the calendar, and the instructions can be executable to, responsive to selection of a first field on the calendar, move into view a selector associated with the computer game event that is associated with the first field.

In some implementations the computer game events can be selected from computer game tournaments, computer game releases, computer game sales events, computer game subscription events.

Without limitations, a computer game event may be identified based at least in part on a wish list associated with a user associated with the calendar, and/or at least one computer game played by a user associated with the calendar.

In example embodiments the instructions can be executable to receive a custom event from user input including an event title and at least one invitee. The instructions may be executable to add the custom event to the calendar, and transmit an invitation to join the event to the invitee. The example instructions can be further executable to, responsive to selection of the custom event, present a list of invitees to the custom event, and responsive to selection of a first invitee from the list of invitees, present information about the invitee.

In non-limiting examples the instructions are executable to present in at least a first field of the calendar a respective color-coded icon for the computer game event associated with the first field indicating a type of event of the computer game event associated with the first field.

In some embodiments the instructions can be executable to present, on the display, a list of event type filters operable to filter from view first selectors based on type of event of the respective computer game events associated with the first selectors.

In some implementations the instructions can be executable to, responsive to selection of a first selector, open a respective Web page associated with the respective computer game event of the first selector to purchase a respective computer game associated with the first selector. In other implementations the instructions may be executable to, responsive to selection of a first selector, open a respective computer game associated with the respective computer game event of the first selector to play the respective computer game associated with the first selector.

In another aspect, a computer-implemented method includes presenting on a computer display a calendar having fields some or all of which indicate respective computer game events. The method further includes linking the events to a series of respective selectors in the display containing information about the respective events not presented on the calendar.

In another aspect, an assembly includes at least one display and at least one processor configured for controlling the display. The processor is programmed with instructions to receive game system information from at least one server, and populate a calendar on the display with the game system information.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example overall architecture;

FIGS. 3-5 illustrate example screen shots of user interfaces (UI) showing the monthly day calendar on the left and example tile-like selectors on the right corresponding to events in the calendar;

FIG. 6 illustrates an example screen shot of a web page that can be accessed by selecting a selector in FIGS. 3-5;

FIGS. 7-13 illustrate example screen shots of UIs for enabling an end user to create a custom event for the calendar;

FIGS. 14-16 illustrate example screen shots of UIs related to subscription management using the calendar;

FIG. 17 illustrates an example screen shot of a UI to enable a user to filter selectors by category;

FIG. 18 illustrates example logic in example flow chart format of the calendar system;

FIG. 19 illustrates example logic in example flow chart format for filtering selectors by category;

FIG. 20 illustrates example logic in example flow chart format for establishing default settings when hot launched into a game from the calendar; and

FIG. 21 illustrates example logic in example flow chart format for moving selectors responsive to selection of a filed in the calendar.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

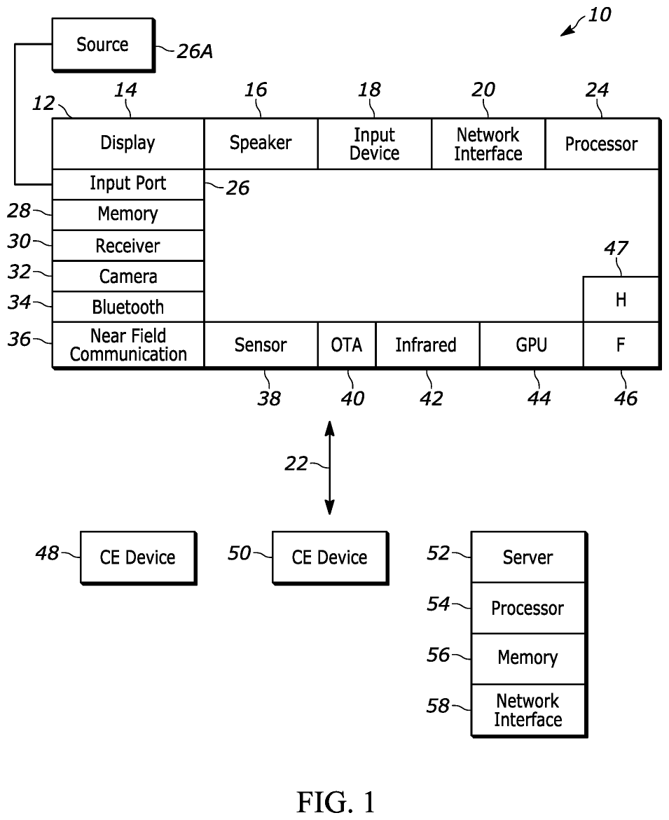

Referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMID) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage mediums 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of motion sensors such as accelerometers, gyroscopes, and magnetometers to determine the location and orientation of the AVD 12 in three dimension or by an event-based sensor such as an event detection sensor (EDS) outputting binary indications of change in direction of a parameter.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command)) that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content.

In the example shown, only two CE devices are shown, it being understood that fewer or greater devices may be used. A device herein may implement some or all of the components shown for the AVD 12 and/or CE devices. Any of the components shown in the following figures may incorporate some or all of the components shown in the case of the AVD 12.

Now in reference to the afore-mentioned at least one server 52, which may be a streaming computer game server, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby. The components shown in the following figures may include some or all components shown in herein. Any user interfaces (UI) described herein may be consolidated and/or expanded, and UI elements may be mixed and matched between UIs.

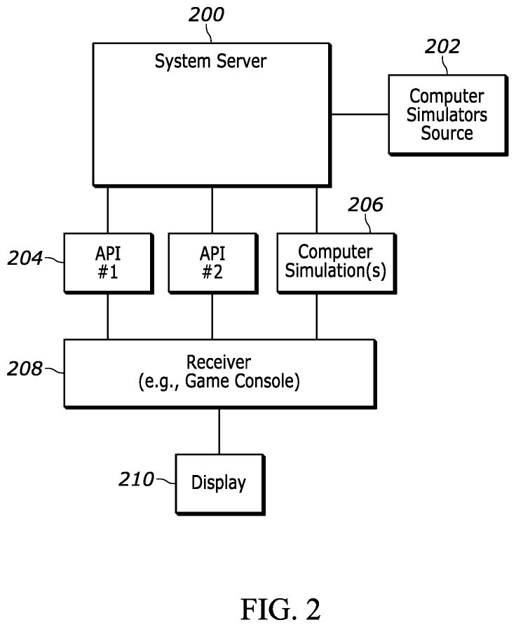

Refer now to FIG. 2. One or more computer simulation servers 200 such as computer game servers such as cloud-based computer game system servers may access one or more computer simulations such as computer games from one or more sources 202, such as other computers, storage of the server 200, etc. The server 200 also may provide one or more application programming interfaces (API) 204 and one or more computer simulations 206 to one or more receivers 208 for presenting the computer simulations in cooperation with the APIs on one or more displays 210 such as a TV. The APIs may be loaded into the receiver during manufacture. In any case, data is exchanged between the server and receiver through the APIs.

A receiver 208 may be implemented by a computer game console or a receiver within the display 210 itself.

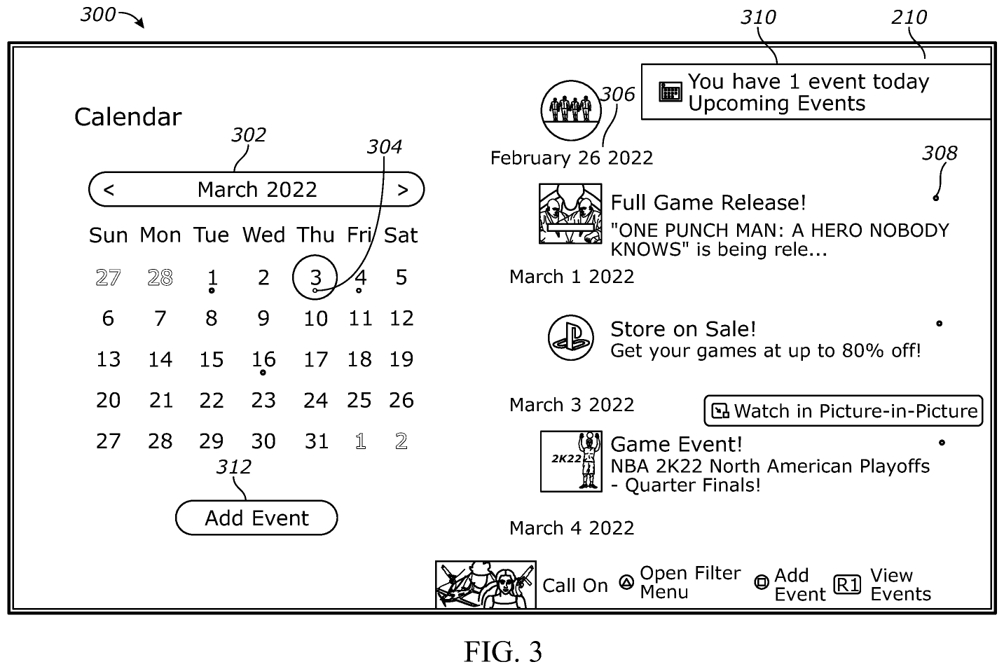

FIG. 3 illustrates a UI 300 that may be presented on any display herein such as the display 210 shown in FIG. 2. In the example shown, a calendar 302 is presented in month format with seven columns, one for each day of the week, and plural rows with fields for each day represented in the calendar. The calendar fields may be populated with information carried in, for example, the APIs 204 shown in FIG. 2. To indicate that a particular day has an even scheduled, a non-alpha-numeric icon 304 may be presented in the field of the calendar corresponding to the day. The icon 304 may be, e.g., a circle or other shape (square, triangle, etc.) or other symbol and it can be color-coded. Specifically, each icon 302 may have a color corresponding to a type of the event it represents, such as a game release event, a sales event, and other types of events disclosed herein, so that an event of a first type is indicated by an icon 304 of a first color and an event of a second type is indicated by an icon of a second color. The same principle may apply to the shape of the icons, in which an event of a first type is indicated by an icon 304 of a first shape and an event of a second type is indicated by an icon of a second shape.

In the example shown, the UI 300 includes, to the right of the calendar 302, a series of selectors 306. In the non-limiting embodiment shown each selector 306 is shaped as a horizontally elongated tile, and the selectors are presented in a single scrollable column. In some examples, each selector 306 may correspond to an event indicated by an icon 304 in the calendar 302, and the selectors may be presented, top to bottom, in the temporal sequence of the respective events. Each selector, as shown, can contain an image representing the event and an alpha-numeric description of the event. In the example shown, the events represented by the selectors include a full game release event, a sales event, and a game play event. Each selector 306 also may include an icon 308 of the same shape and size as the event type icon 304 in the calendar 302 for the corresponding event.

An advisory 310 may be presented for each event occurring at the current day. Also, a customized event addition selector 312 may be presented and may be selectable for purposes to be shortly described. When a day field is selected from the calendar 302, the list of selectors 306 may scroll up or down until the selector associated with the selected field in the calendar appears, e.g., as the center-most selector displayed.

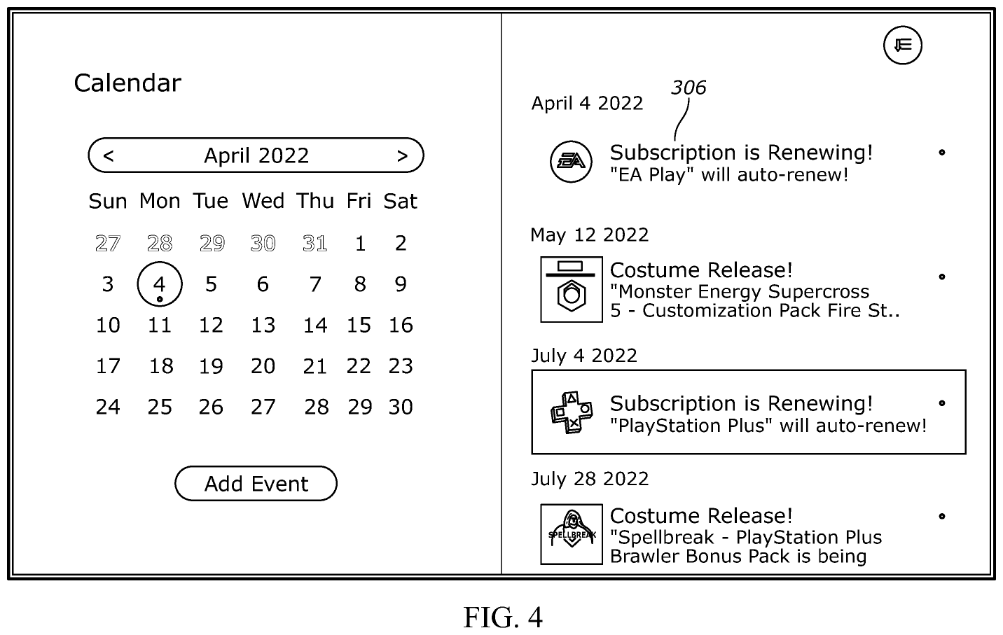

FIG. 4 illustrates that additional events represented by selector 306 may include an automatic renewal date for a subscription (or a subscription end date) and a costume release date pertaining to the release of costumes for purchase associated with a particular game. The events shown in FIG. 4 are not exclusive and are non-limiting.

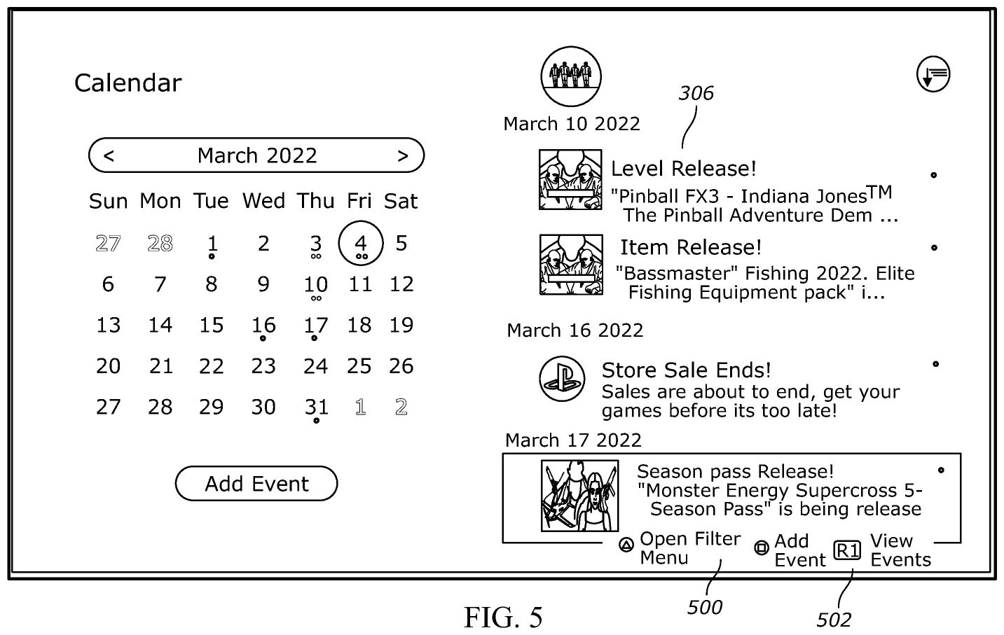

FIG. 5 illustrates that additional events represented by selector 306 may include a release date for a particular level of a particular game, a release date for a game-associated item, and a release date at which a season pass for game spectating or game play becomes available. In FIG. 5, a filter selector 500 also is presented and can be selected to open a filter UI described further herein. A view events selector 502 may be presented and can be selected to view more events than currently presented on screen. The events shown in FIG. 5 are not exclusive and are non-limiting.

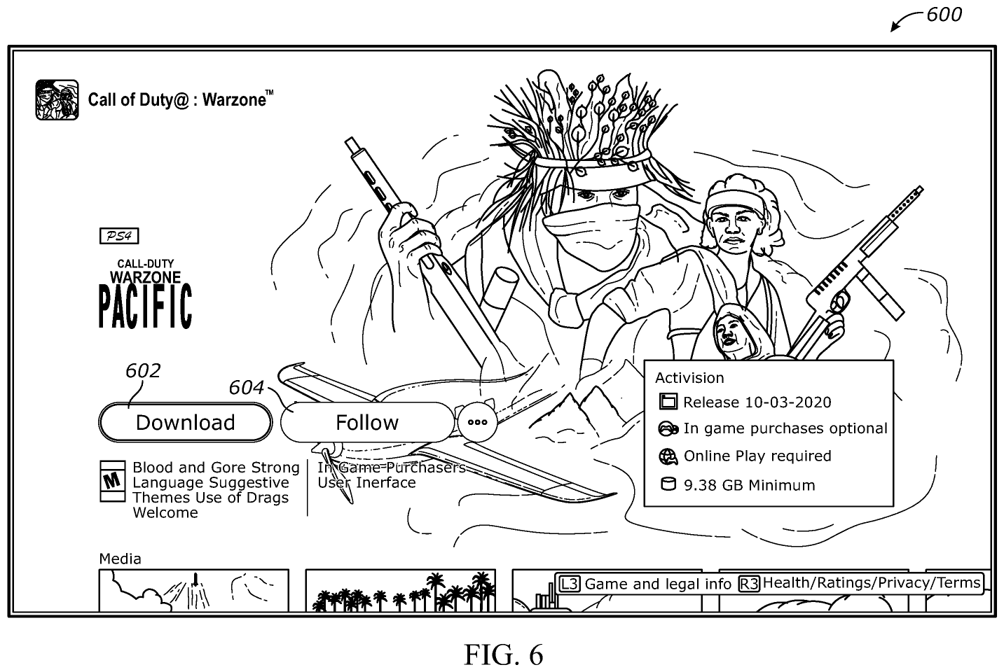

A selector 306 may be selected using a game controller or point and click device or touch screen or other device to invoke a web page associated with the respective event, such as the web page 600 shown in FIG. 6. The web page 600 can be navigated to purchase the game associated with the event, for example by selecting a download selector 602. The user may elect to follow events associated with the game represented in FIG. 6 by selecting a follow selector 604. In some cases, selection of a selector 306 from FIG. 3 or selection of a play button from the web page of FIG. 6 may cause the associated game to be launched on the user's device, in effect placing the user immediately into the game as a spectator or player.

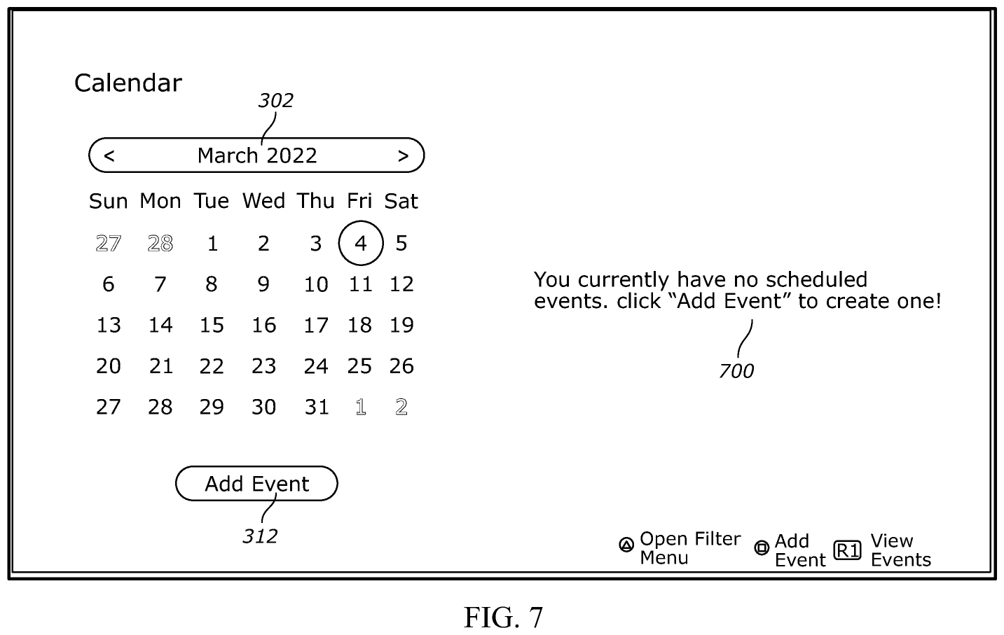

FIGS. 7-13 illustrate techniques for a user to add a custom event to the calendar 302. In FIG. 7, only the calendar 302 appears because it is not yet populated by the user or auto-populated with events obtained through an API. A prompt 700 may be presented in such a case advising the user to select the add event selector 312 to create a custom event for the calendar.

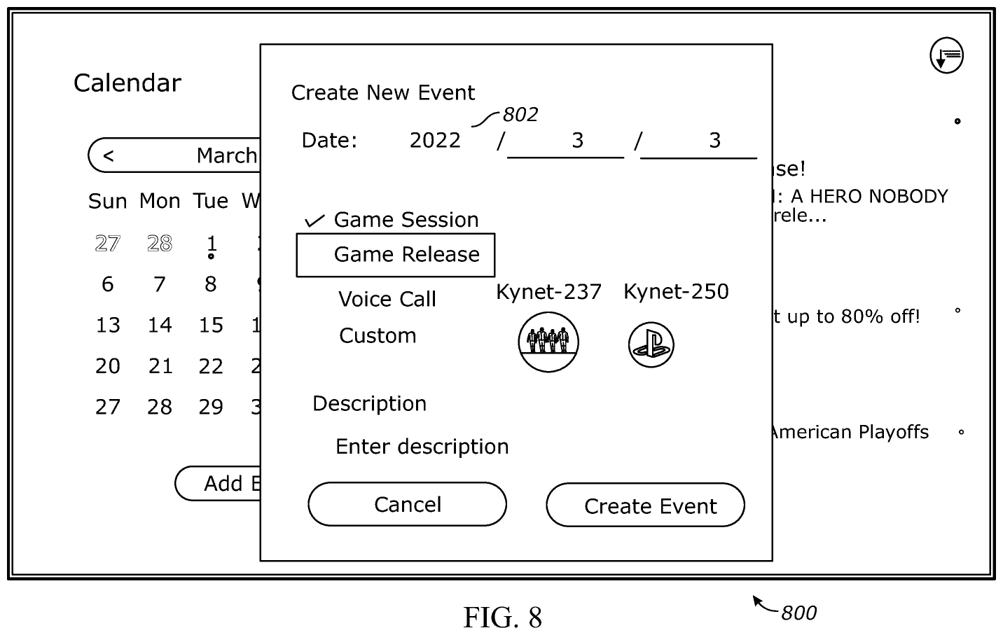

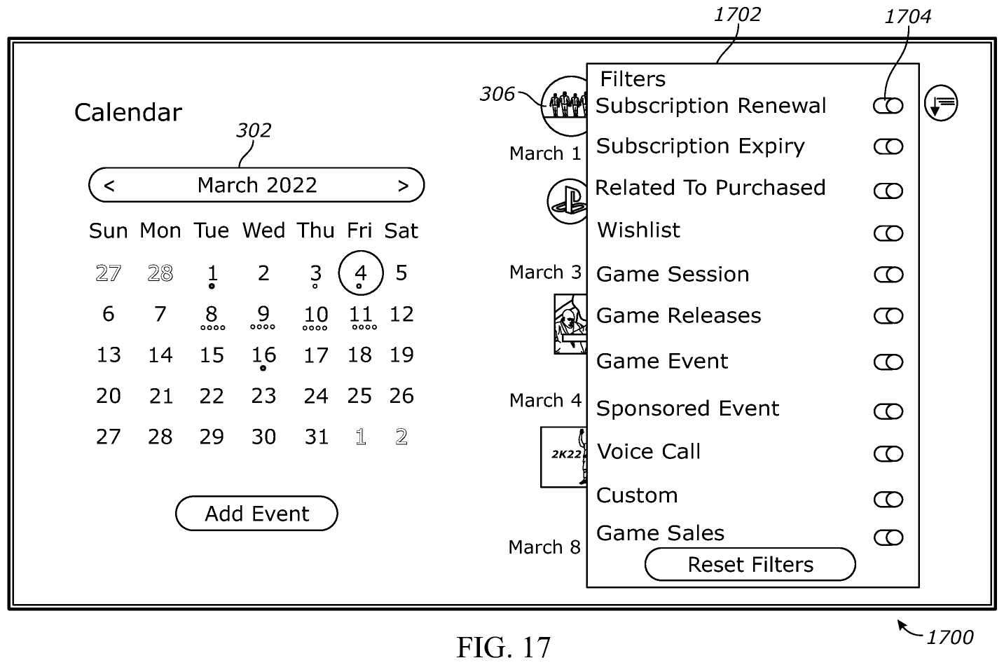

Assuming the add event selector 312 is selected, FIG. 8 shows that a “create new event” UI 800 may be presented with event type selectors 802 that include a game session, a game release from the system or publisher, a voice call, and a custom user-defined type. Other example event types include subscription renewal events, subscription expiration events, events related to prior purchases, events derived from a wish list the user has populated in the system, game play events, sponsored events, and game sales events (some of which events are listed in the filter UI for example shown in FIG. 17).

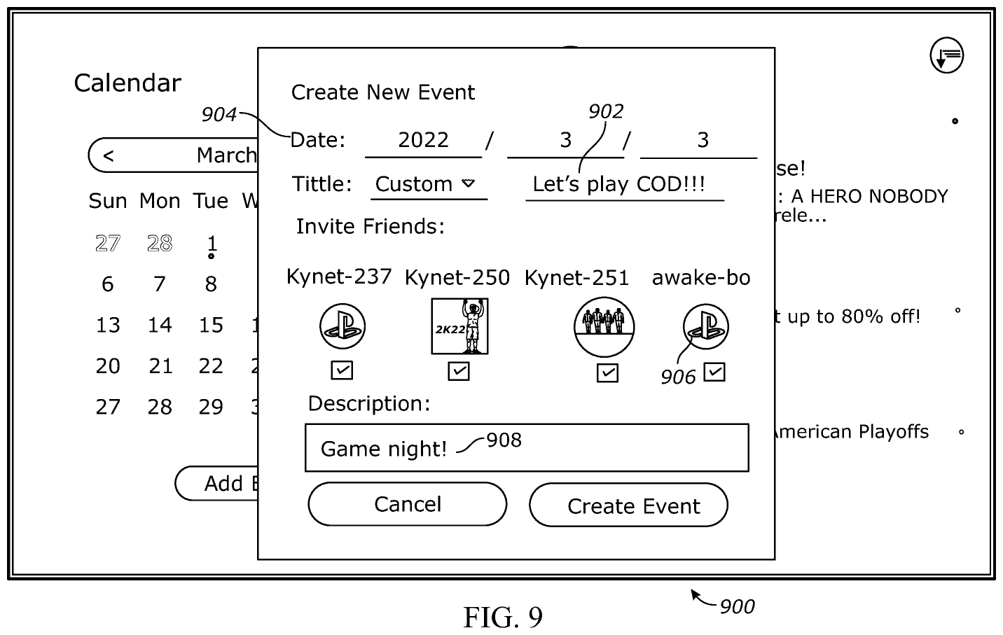

For disclosure purposes, assume the user has selected “custom”, which may invoke the UI 900 of FIG. 9. In FIG. 9, a title field 902 has been automatically populated with the type “custom” and the user has entered a title of the specific custom event, in the example shown, “let's play COD”. The user can also set the date for the event using date fields 904.

Moreover, the user's friend list stored by the system may be accessed and a list 906 of friends with respective avatars may be presented from which the user can select one or more invitees to the event. The user has entered into a description field 908 that the custom event can be described as game night.

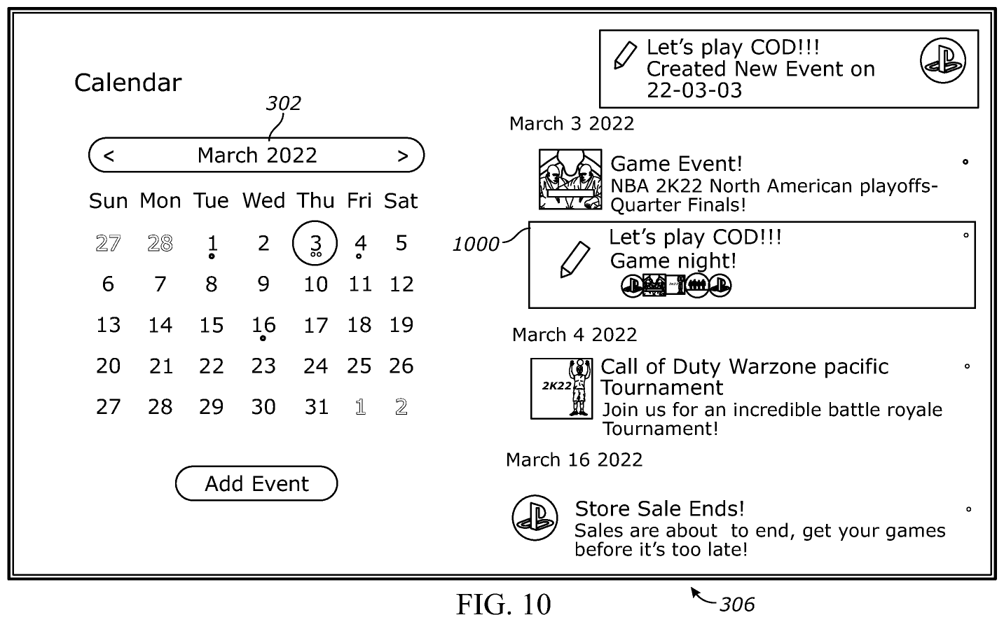

In response to the entries in FIG. 9, FIG. 10 illustrates a UI similar to that shown in FIG. 3 having a calendar 302 (with event type indicators 304 in calendar fields) and next to the calendar 302, a series of selectors 306 including a selector 1000 reflecting the custom event created in FIGS. 7-9, in which the title of the event appears, the description of the event, and icons of the invited friends. Note that FIG. 10 assumes that other calendar events have been auto-populated using data from, e.g., the APIs to indicate a basketball game event, a game tournament, and a sales event.

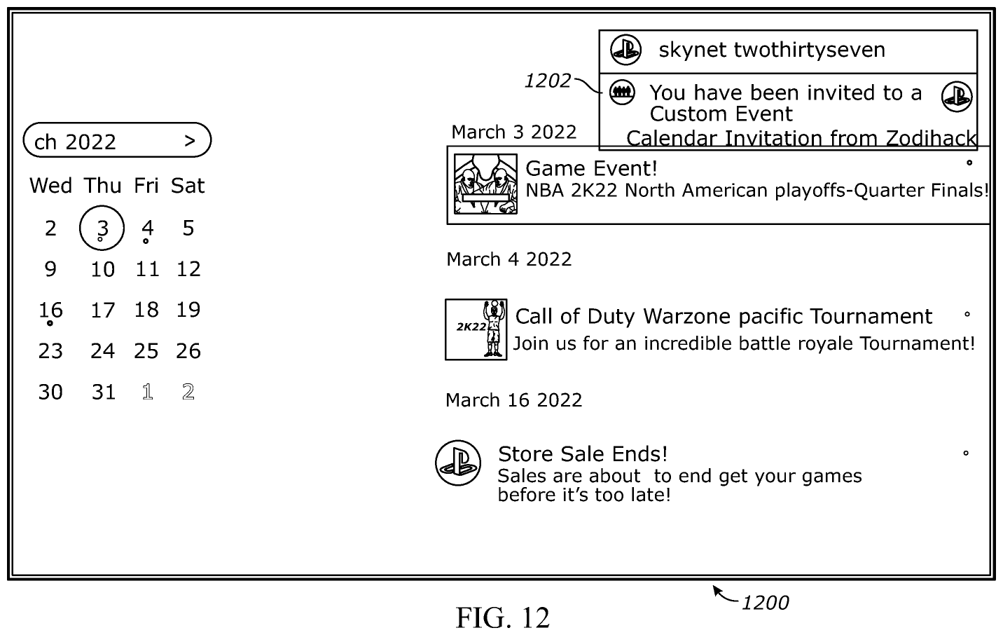

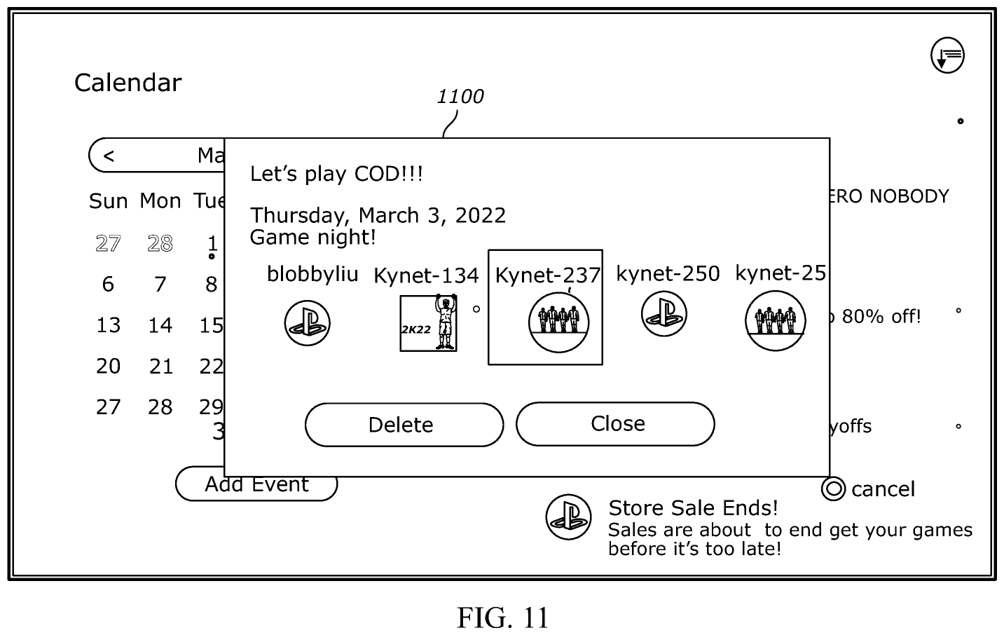

FIG. 11 illustrates that clicking on the custom event selector 1000 in FIG. 10 may result in an overlay 1100 being presented partially or completely over the calendar 302 and series of selectors 306. The overlay 1100 contains more detailed information about the custom event created in FIG. 9, including the date, title, description, and friends list showing both icons and friend names. Events, both custom and auto-populated, may be deleted from the calendar, as indicated by the “delete” button in FIG. 11.

FIG. 12 then illustrates a UI 1200 that may be presented on the display of an invitee selected from the friend list in FIG. 9, which advises at 1202 that the invitee has been invited to a custom event by the inviting user.

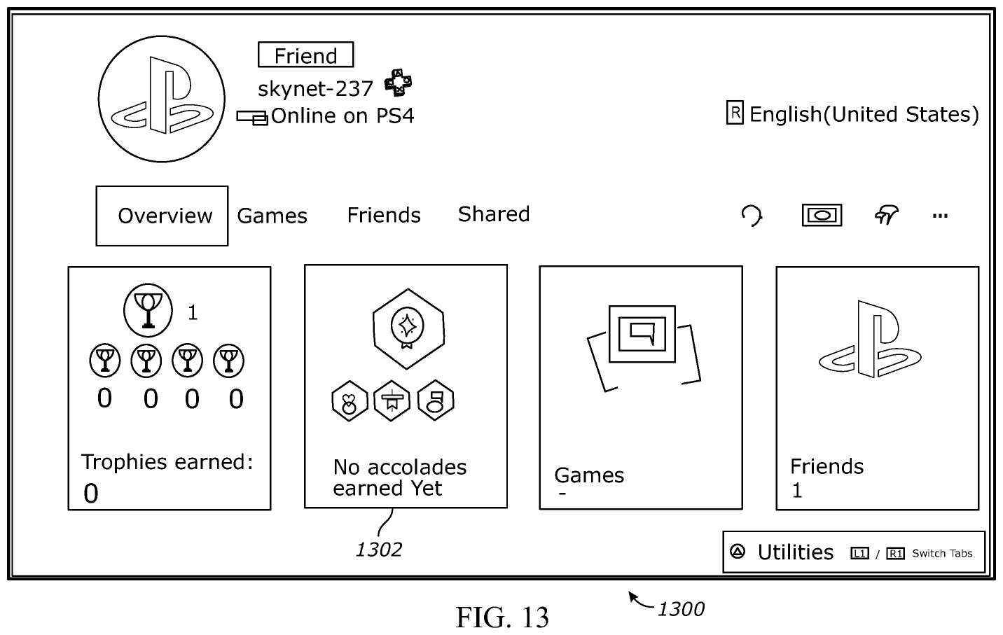

Should an inviter or invitee wish to learn more about another user in the event, a user icon may be selected to invoke the UI 1300 of FIG. 13. The user selected is “Skynet-237” and user data 1302 appears on screen in an overlay. Without limitation, the user data 1302 may include the number of trophies earned by the selected user, the number of accolades earned by the selected user, games associated with the selected user, and friends of the selected user.

Refer now to FIGS. 14-16 for example screen shots of UIs related to subscription management using the calendar. A UI 1400 in FIG. 14 may be invoked from, e.g., a settings selector or other system selector to list various management activities that the user may wish to execute. Without limitation these activities, each of which may be represented by a respective selector 1402, include payment methods, enabling a user to select how to pay for certain events, redeem codes, enabling a user to redeem any available discount codes for product purchases, and transaction history, enabling a user to view his prior transaction history.

The activities in the UI 1400 may further include purchase settings, selectable to allow a user to establish personal settings for purchases such as address, credit card number, etc., and add funds, allowing a user to add money to his system account, e.g., from a credit card or bank account. The activities also may include subscriptions to allow a user to manage subscriptions in the system, and game and application services.

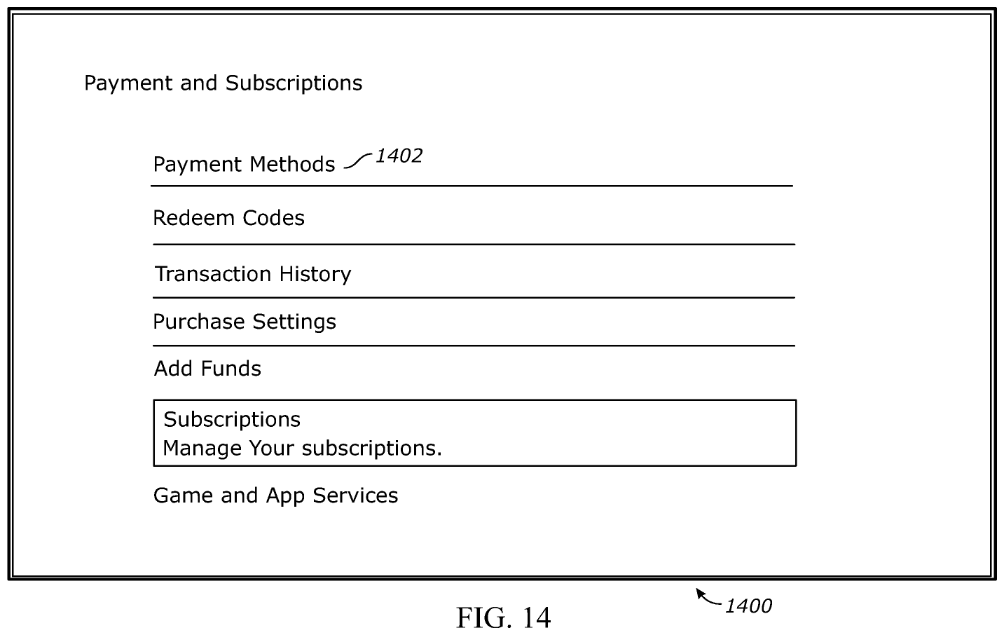

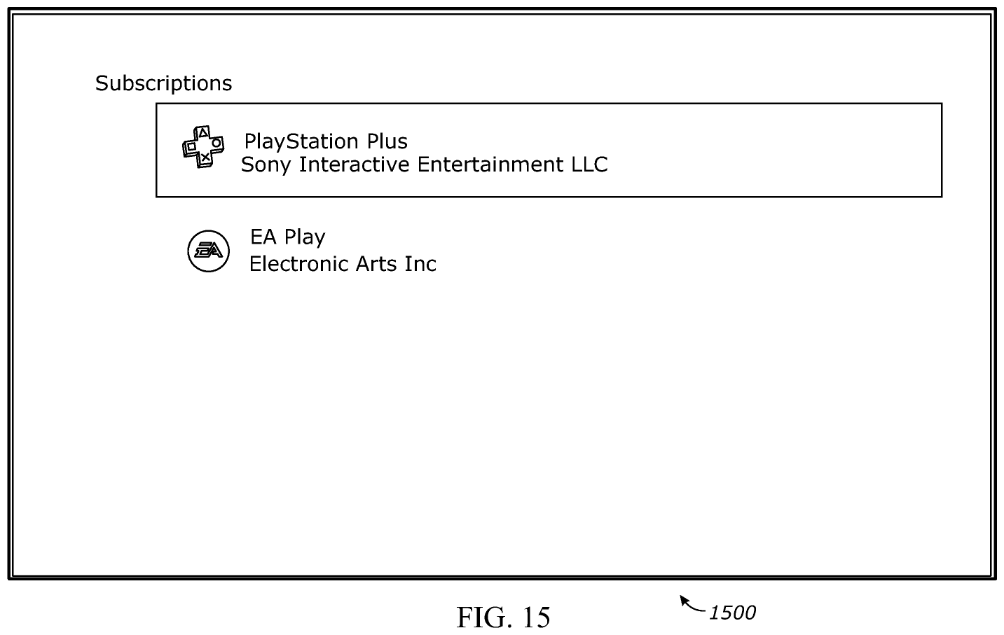

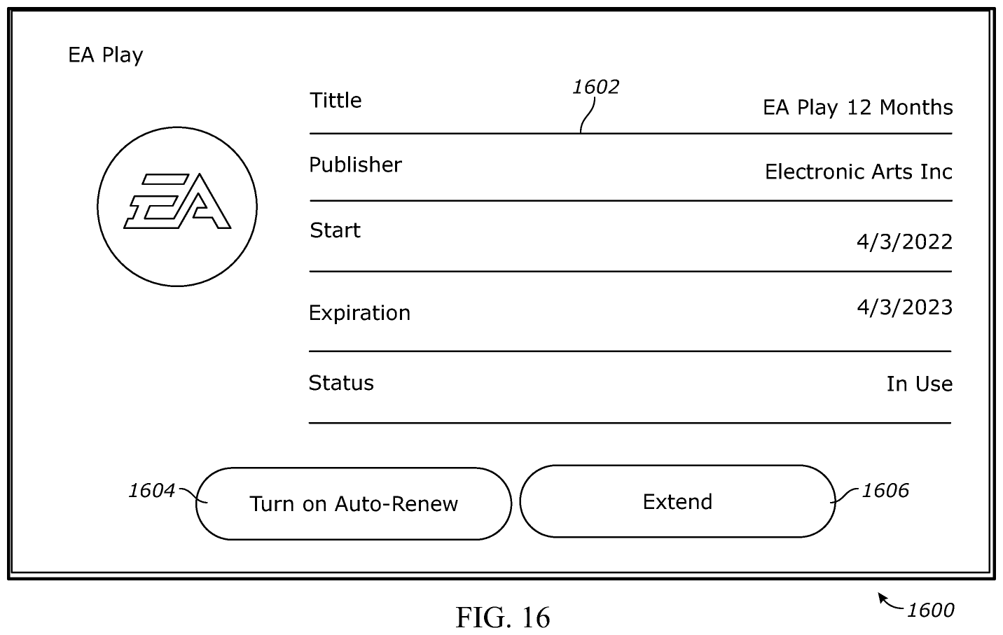

Assume the user has selected the subscriptions selector 1402 from the list of activities. In response, a UI 1500 may be presented as shown in FIG. 15 listing the user's system subscriptions, each of which may be selectable to invoke the UI 1600 of FIG. 16 which gives specific information about the subscription selected from the list in FIG. 15. The UI 1600 of FIG. 16 can include subscription data 1602 which may include subscription title, publisher, start date, expiration date, and status of the subscription. Additionally, management selectors may be presented including a selector 1604 selectable to enable automatic renewal of the subscription and an extend selector 1606 selectable to extend the expiration date of the subscription.

FIG. 17 illustrates an example screen shot of a UI 1700 to enable a user to filter selectors by category. The UI 1700 may be invoked, e.g., by selecting the filter selector 500 in FIG. 5. A list 1702 of event types is superimposed over the calendar 302 and/or series of selectors 306, with each entry on the list including a respective on/off selector 1704. By turning off the filter selector 1704 of an event type, events of that type will appear in the series of selectors 306. By turning on a selector 1704 of an event type, events of that type will not appear in the series of selectors 306, enabling a user to declutter the series of selectors 306 to better focus on just the event type or types of interest. It is to be understood that equivalently, a filter may be turned off to prevent display of events of that type and turned on to permit display of events of that type.

Note that in addition to filter selectors by event type, filter selectors may be provided to filter from view events designated as being related to sex, filters to permit only age-appropriate events to appear in the UIs, and filters to prevent events from appearing based on violence and profanity. A master or parent account can set such filters using administrator credentials.

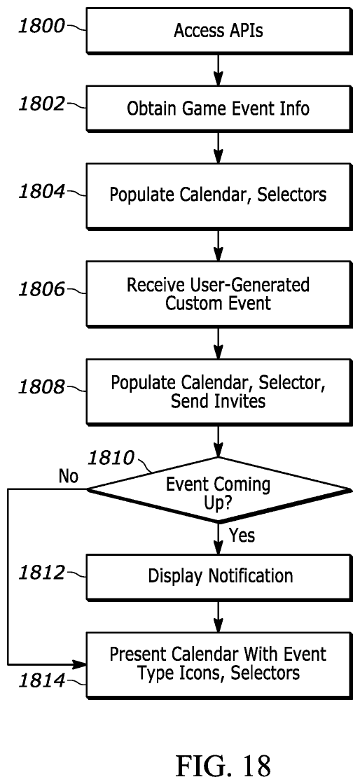

Refer now to FIG. 18 for logic that may be executed by, for example, any of the processors/devices described herein. Commencing at block 1800, a receiver for example may access sources of metadata including one or more of the APIs 204 shown in FIG. 2 to obtain game and other information at block 1802. By way of example, APIs may include information including play and release dates of games followed by the user, in which all previous and future releases are listed and may be used to populate the calendar 302 (and associated series of selectors 306) at block 1804. Similarly, APIs may be accessed for date and time information related to game add-ons, games previously played by the user, tournaments associated with a game, sales events, subscription events, and so on.

Also, the logic may proceed to block 1806 to receive user-defined custom events as described herein, populating the calendar and selectors with those events, and sending invitations to user-selected friends at block 1808.

If it is determined at decision diamond 1810 that a calendar event is approaching within, e.g., a time or number of days threshold, a notification may be presented at block 1812 of the impending event. Block 1814 indicates that the calendar 302 and selectors 306 are populated according to description here for example and presented on any of the displays disclosed herein.

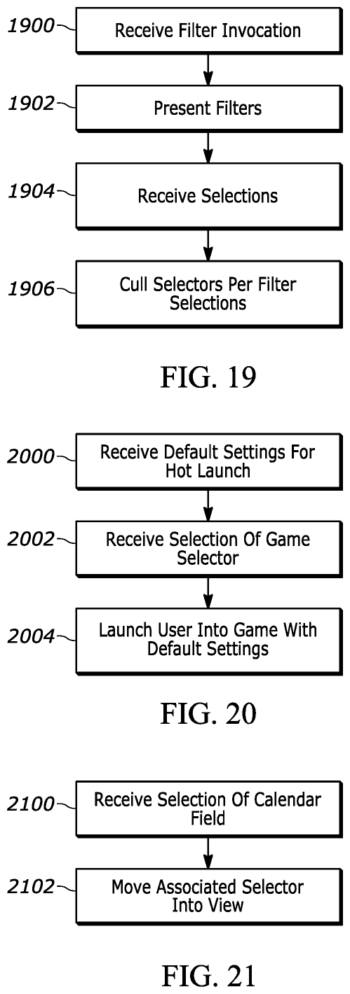

FIG. 19 illustrates additional logic. Commencing at block 1900 the filter UI is invoked and a list of filters is presented at block 1902 in response. Moving to block 1904, user selections of filters to be applied is received and in response, at block 1906 selectors are culled from display according to the selected filtering.

As discussed above, a selector 306 and/or the web page invoked by the selector may be used to “hot launch” the user into the game associated with the selector by automatically loading and executing the game without further user action. The game may be executed in spectating mode or player mode. The user may wish to invoke settings for such as hot launch which configure the system for the user.

Commencing at block 2000 default settings to be applied for hot launch may be received. The user may input these settings or change factory-defined settings in this regard. When a game selector selection is received at block 2002, e.g., from the series of selectors 306 shown in FIG. 3, the game is launched on the user's computer at block 2004 with the default settings.

Without limitation, default settings may include, e.g., microphone off, audio settings, volume settings, whether the Y-axis for joystick operation is to be inverted, etc.

FIG. 21 illustrates that a field may be selected from the calendar 302 shown in FIG. 3 at block 2100 and in response, at block 2102 the associated selector from the series of selectors 306 may be moved into view by scrolling the list up or down.

Potential revenue may be derived according to principles discussed herein, including being accorded monetary reward for sponsored events, sales/release notifications (followed game releases, followed add-on releases, upcoming sales, limited time DLC), subscription end/renewal reminders, and premium features.

While the particular embodiments are herein shown and described in detail, it is to be understood that the subject matter which is encompassed by the present invention is limited only by the claims.

What is claimed is:

1. A device comprising:
at least one computer storage that is not a transitory signal and that comprises instructions executable by at least one processor to:
present on a computer display a calendar comprising fields some or all of which indicate respective computer game events; and
present, next to the calendar, plural selectors each associated with a computer game event and selectable to open a respective Web page associated with the respective computer game event of the respective selector.

2. The device of claim 1, comprising the display and the processor.

3. The device of claim 1, wherein the computer game events represented by the selectors are the same computer game events on the calendar, and the instructions are executable to:
responsive to selection of a first field on the calendar, move into view a selector associated with the computer game event that is associated with the first field.

4. The device of claim 1, wherein the computer game events are selected from computer game tournaments, computer game releases, computer game sales events, computer game subscription events.

5. The device of claim 1, wherein at least one of the computer game events is identified based at least in part on a wish list associated with a user associated with the calendar and/or based on a user following a game.

6. The device of claim 1, wherein at least one of the computer game events is identified based at least in part on at least one computer game played by a user associated with the calendar.

7. The device of claim 1, wherein the instructions are executable to:
receive a custom event from user input comprising an event title and at least one invitee;
add the custom event to the calendar; and
transmit an invitation to join the event to the invitee.

8. The device of claim 7, wherein the instructions are executable to;
responsive to selection of the custom event, present a list of invitees to the custom event; and
responsive to selection of a first invitee from the list of invitees, present information about the invitee.

9. The device of claim 1, wherein the instructions are executable to:
present in at least a first field of the calendar a respective color-coded icon for the computer game event associated with the first field indicating a type of event of the computer game event associated with the first field.

10. The device of claim 1, wherein the instructions are executable to:
present, on the display, a list of event type filters operable to filter from view first selectors based on type of event of the respective computer game events associated with the first selectors.

11. The device of claim 1, wherein the instructions are executable to:
responsive to selection of a first selector, open a respective Web page associated with the respective computer game event of the first selector to purchase a respective computer game associated with the first selector.

12. The device of claim 1, wherein the instructions are executable to:
responsive to selection of a first selector, open a respective computer game associated with the respective computer game event of the first selector to play the respective computer game associated with the first selector.

13. A computer-implemented method, comprising:
presenting on a computer display a calendar comprising fields some or all of which indicate respective computer game events; and
linking the events to a series of respective selectors in the display containing information about the respective events not presented on the calendar.

14. The method of claim 13, comprising:
responsive to selection of a first field on the calendar, moving into view a selector associated with the computer game event that is associated with the first field.

15. The method of claim 13, wherein the computer game events are selected from computer game tournaments, computer game releases, computer game sales events, computer game subscription events.

16. The method of claim 13, comprising identifying at least one of the computer game events at least in part on a wish list associated with a user associated with the calendar, at least one computer game played by a user associated with the calendar, or both the wish list and the computer game played by the user.

17. The method of claim 13, comprising:
receiving a custom event from user input comprising an event title and at least one invitee;
adding the custom event to the calendar; and
transmitting an invitation to join the event to the invitee.

18. The method of claim 13, comprising:
presenting in at least a first field of the calendar a respective color-coded icon for the computer game event associated with the first field indicating a type of event of the computer game event associated with the first field.

19. The method of claim 13, comprising:
presenting, on the display, a list of event type filters operable to filter from view first selectors based on type of event of the respective computer game events associated with the first selectors.

20. An assembly comprising:
at least one display;
at least one processor configured for controlling the display, the processor being programmed with instructions to:
receive game system information from at least one server; and
populate a calendar on the display with the game system information.
